(19) United States
(12) Patent Application Publication
(10) Pub. No.: US 2025/0199531 A1
(43) Pub. Date: Jun. 19, 2025

(54) REMOTE OPERATION SYSTEM

(71) Applicant: Toyota Jidosha Kabushiki Kaisha, Toyota-shi (JP)

(72) Inventors: Yuki SUEHIRO, Susono-shi (JP); Shuichi Tamagawa, Kitanagoya-shi (JP)

(73) Assignee: Toyota Jidosha Kabushiki Kaisha, Toyota-shi (JP)

(21) Appl. No.: 18/956,023

(22) Filed: Nov. 22, 2024

(30) Foreign Application Priority Data
Dec. 14, 2023 (JP) 2023-210779

(51) Int. Cl. G05D 1/227

(52) U.S. Cl. CPC G05D 1/227

(57) ABSTRACT

A remote operation system for remote operation of mobility is provided. The external operator is a remote operator outside the remote operation management center that manages remote operation. The external operator terminal is used by the external operator for remote operation. The remote operation system calculates a score indicating the suitability of at least one of the external operator and the external operator terminal to the remote operation based on the state information indicating at least one of the state of the external operator and the state of the external operator terminal. Then, the remote operation system selects at least one of the first external operator and the first external operator terminal to be assigned to the remote operation of the target mobility based on the score.

### CROSS-REFERENCE TO RELATED APPLICATION

This application claims priority to Japanese Patent Application No. 2023-210779 filed on Dec. 14, 2023, incorporated herein by reference in its entirety.

### BACKGROUND

### 1. Technical Field

The present disclosure relates to a remote operation of a mobility.

### 2. Description of Related Art

Japanese Unexamined Patent Application Publication No. 2020-42764 discloses a vehicle remote operation assistance system. When a number of operators is not enough, the vehicle remote operation assistance system requests remote operation assistance to an external operator within an external center separated from a control center.

### SUMMARY

It can be considered that an external operator outside of a remote operation management center performs a remote operation of a mobility. In relation to the external operator, there can be an appropriate state and an inappropriate state for a remote operation. Similarly, in relation to an external operator terminal used by the external operator for a remote operation, there can be an appropriate state and an inappropriate state for the remote operation. If the external operator or external operator terminal of an inappropriate state for a remote operation is selected, accuracy of the remote operation decreases.

One viewpoint of the present disclosure is related to a remote operation system for a remote operation of a mobility.

An external operator is a remote operator outside of a remote operation management center that manages the remote operation of the mobility.

An external operator terminal is a remote operator terminal configured to be used by the external operator for the remote operation.

The remote operation system includes one or a plurality of processors.

The one or a plurality of processors acquires state information that shows at least one of a state of the external operator and a state of the external operator terminal.

The one or a plurality of processors calculates a score that shows a suitability of at least one of the external operator and the external operator terminal with respect to the remote operation based on the state information.

The one or a plurality of processors selects at least one of a first external operator and a first external operator terminal assigned to the remote operation of a target mobility based on the score.

According to the present disclosure, information of a remote operation of a mobility is secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for explaining an outline of a remote operation system;

FIG. 2 is a conceptual diagram for explaining an outline of allocation processing by the management system;

FIG. 3 is a conceptual diagram illustrating a configuration example of a remote operation system;

FIG. 4 is a flowchart illustrating an assignment process by the management system;

FIG. 5 is a conceptual diagram for describing an exemplary score in a first aspect;

FIG. 6A is a conceptual diagram for explaining a second aspect; and

FIG. 6B is a conceptual diagram for explaining a third aspect.

### DETAILED DESCRIPTION OF EMBODIMENTS

### Remote Support System

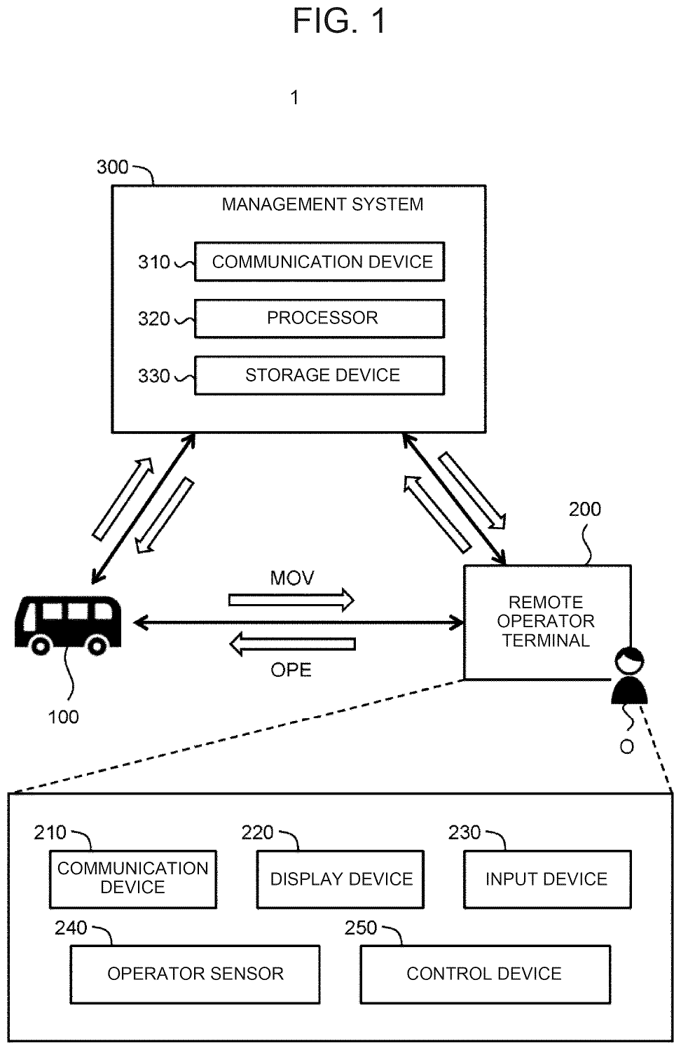

FIG. 1 is a conceptual diagram for explaining an outline of a remote operation system 1 according to the present embodiment. The remote operation system 1 is a system for remote operation of the mobility 100. Remote operation is a concept including remote operation. The remote operation system 1 includes a mobility 100, a remote operator terminal 200, and a management system 300. The mobility 100, the remote operator terminal 200, and the management system 300 can communicate with each other via a communication network. For example, the mobility 100 can wirelessly communicate with the remote operator terminal 200 and the management system 300 via a wireless communication network. The remote operator terminal 200 and the management system 300 can communicate with each other via a wired/wireless communication network.

### Mobility

Mobility 100 is a mobile object that can be moved. Mobility 100 may be manually operated by an operator riding on mobility 100. The mobility 100 may include an autonomous mobility function. In either case, mobility 100 is configured to be able to be operated remotely as needed. That is, the mobility 100 is an object of remote operation by the remote operation system 1.

The type of mobility 100 to be subjected to remote operation is not limited to one, and may be a plurality. For example, the mobility 100 is a vehicle that travels on a public road. As another example, mobility 100 may be a vehicle used in a factory. As yet another example, mobility 100 may be a special compact vehicle. As yet another example, mobility 100 may be a construction machine. As yet another example, the mobility 100 may be a robot. As yet another example, mobility 100 may be a flying object. As yet another example, mobility 100 may be a ship. As yet another example, mobility 100 may be a vehicle in an amusement park.

### Remote Operator Terminal

The remote operator terminal 200 is a terminal device used when the remote operator O remote operations the mobility 100. That is, the remote operator terminal 200 is configured to be used by the remote operator O for remote operation of the mobility 100. Examples of the remote operator terminal 200 include a cockpit-type terminal, a PC, tablets, and a smart phone. The single remote operator terminal 200 may be configured to be capable of remote operation of various types of mobility 100.

The remote operator terminal 200 includes a communication device 210, a display device 220, an input device 230, an operator sensor 240, and a control device 250.

The communication device 210 communicates with the mobility 100 and the management system 300.

The display device 220 displays various kinds of information to a remote operator O who performs remote operation. In other words, the display device 220 presents various kinds of information to the remote operator O by displaying various kinds of information. Examples of the display device 220 include a display and a touch panel.

The input device 230 receives an input from the remote operator O. For example, the input device 230 includes a remote operation member that is operated when the remote operator O remote operations the mobility 100. Examples of the remote operation member include a handle, an accelerator pedal, a brake pedal, a joystick, a cross key, and a switch. The remote operation member may be a touch panel. The input device 230 may include an information input unit other than the remote operation member.

The operator sensor 240 is a sensor for monitoring the state of the remote operator O. For example, the operator sensor 240 includes a biometric sensor that detects biometric information of the remote operator O. Examples of the biological information include body temperature, heart rate, blood pressure, sweat amount, and the like.

The control device 250 controls the remote operator terminal 200. The control device includes one or more processors and one or more storage devices. The processor executes various kinds of processing. Examples of the processor include CPU, GPU, ASIC, FPGA, and the like. The processor may also be referred to as a circuitry or a processing circuitry. The storage device stores various types of information. Examples of the storage device include a volatile memory, a nonvolatile memory, and an HDD, SSD. The functions of the control device 250 may be realized by cooperation of the processor executing the control program and the storage device. The control program is stored in the storage device. Alternatively, the control program may be recorded in a computer-readable recording medium.

### Management System (Manager)

The management system 300 is a computer that manages the remote operation system 1. The management system 300 may include a plurality of servers that perform distributed processing. The management system 300 manages a plurality of remote operators O and a plurality of remote operator terminals 200.

The management system 300 includes a communication device 310, one or more processors 320 (hereinafter simply referred to as processors 320), and one or more storage devices 330 (hereinafter simply referred to as storage devices 330). The communication device 310 communicates with the mobility 100 and the remote operator terminal 200.

The processor 320 executes various processes. Exemplary processors 320 include general purpose processors, special purpose processors, CPU, GPU, ASIC, FPGA, integrated circuits, conventional circuits, and/or combinations thereof. The processor 320 may also be referred to as a circuitry or a processing circuitry. Circuitry is hardware programmed to implement the described functions, or hardware that performs the functions. The storage device 330 stores various types of information. Examples of the storage device 330 include a volatile memory, a nonvolatile memory, and an HDD, SSD. The functions of the management system 300 may be realized by cooperation of the processor 320 executing the management program and the storage device 330. The management program is stored in the storage device 330. Alternatively, the management program may be recorded in a computer-readable recording medium. The management program may be provided via a network.

Before the start of the remote operation of the mobility 100, the processor 320 executes an “assignment process” in which the appropriate remote operator O and the appropriate remote operator terminal 200 are assigned to the remote operation of the mobility 100.

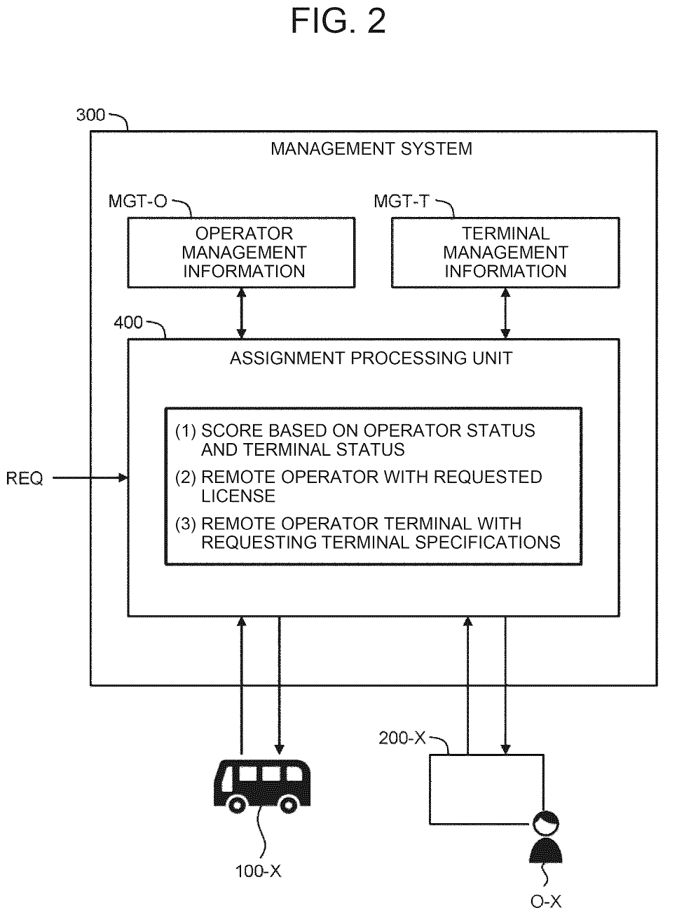

FIG. 2 is a conceptual diagram for explaining an outline of allocation processing by the management system 300. The storage device 330 stores an operator management information MGT-O and a terminal management information MGT-T. The operator management information MGT-O is information for managing a plurality of remote operators O. For example, the operator management-information MGT-O indicates, for each remote operator O, an operator ID, a possession license, a usage status (availability), an assignment status, a work history, and the like. The terminal management information MGT-T is information for managing the plurality of remote operator terminals 200. For example, the terminal management-information MGT-T indicates, for each remote operator terminal 200, a terminal ID, a specification, a usage state (availability), an assignment state, a movement history, and the like.

Mobility 100, which is a target of remote operation, is hereinafter referred to as “target mobility 100-X”. The remote operator O assigned to the remote operation of the target mobility 100-X is hereinafter referred to as “first remote operator O-X”. The remote operator terminal 200 assigned to remote operation of the target mobility 100-X is hereinafter referred to as “first remote operator terminal 200-X”.

The management system 300 (processing unit 320) includes an assignment processing unit 400 that executes assignment processing. First, the assignment processing unit 400 receives a remote operation request REQ related to the target mobility 100-X. For example, the remote operation request REQ is issued from the target mobility 100-X itself. The target mobility 100-X transmits the remote operation request REQ to the management system 300 via the radio communication. Alternatively, the remote operation request REQ may be transmitted to the management system 300 from a service provider affiliated with the remote operation system 1.

The remote operation request REQ indicates the type of the target mobility 100-X and the content of the desired remote operation. In response to the received remote operation request REQ, the assignment processing unit 400 assigns the first remote operator O-X and the first remote operator terminal 200-X to the remote operation of the target mobility 100-X. More specifically, the assignment processing unit 400 selects an appropriate first remote operator O-X from the plurality of remote operators O on the basis of the remote operation request REQ and the operator-management-information MGT-O. Further, the assignment processing unit 400 selects an appropriate first remote operator terminal 200-X from the plurality of remote operator terminals 200 based on the remote operation request REQ and the terminal management information MGT-T.

### Flow of Information During Remote Operation

The mobility 100 is equipped with various sensors including a camera. The camera captures an image of a situation around the mobility 100. The camera provides a video indicative of a situation around mobility 100. The mobility information MOV is information obtained by various sensors, and includes at least an image captured by a camera. The mobility information MOV may include the location and status of mobility 100 (e.g., velocity, steering angle, etc.). Mobility 100 transmits the mobility information MOV to remote operator terminal 200.

The remote operator terminal 200 receives the mobility information MOV transmitted from the mobility 100. The remote operator terminal 200 presents the mobility information MOV to the remote operator O. Specifically, the remote operator terminal 200 displays a video or the like on the display device 220. The remote operator O looks at the displayed information, recognizes the situation around the mobility 100, and remote operations the mobility 100. Specifically, the remote operator O operates the remote operation member of the input device 230. The operation amount of the remote operation member is detected by a sensor installed in the remote operation member. The control device 250 generates a remote operation data OPE reflecting an operation amount of the remote operation member by the remote operator O. Then, the control device 250 transmits the remote operation data OPE to the mobility 100 via the communication device 210.

The mobility 100 receives the remote operation data OPE transmitted from the remote operator terminal 200. The mobility 100 performs mobility control in accordance with the received remote operation data OPE. In this way, remote operation of the mobility 100 is realized.

### Use of External Operators

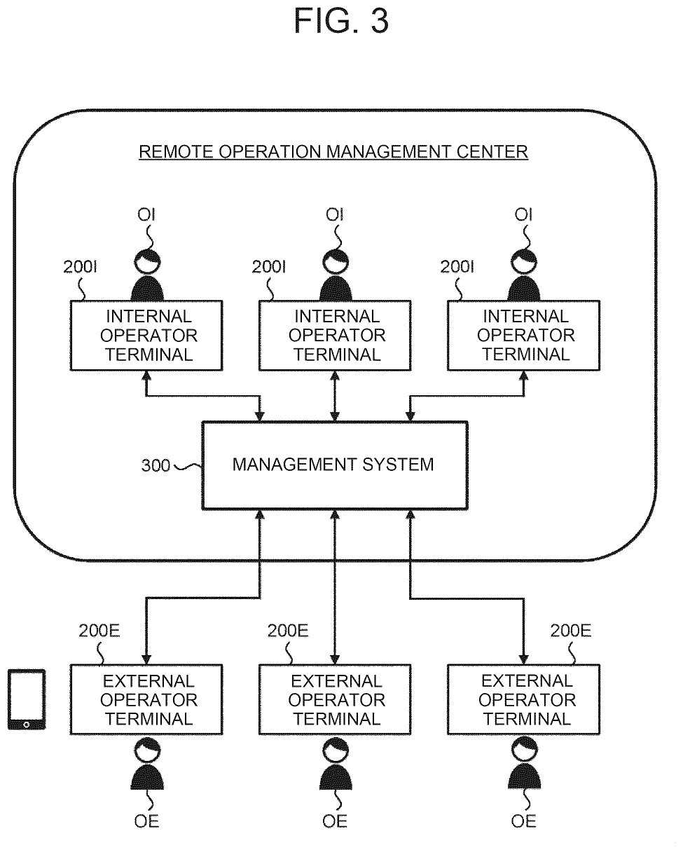

FIG. 3 is a conceptual diagram illustrating a configuration example of the remote operation system 1. The remote operation management center is a facility for managing remote operation of the mobility 100. The remote operation management center is provided at a predetermined site or in a predetermined building. The management system 300 is installed in a remote operation management center. According to the present embodiment, the remote operator O and the remote operator terminal 200 are classified into two types from the viewpoint of the inside and outside of the remote operation management center.

The “Internal Operator OI” is the remote operator O in the remote operation management center. In other words, the internal operator OI is engaged in remote operation servicing within the remote operation management center. The internal operator OI may be a full-time remote operator O. The “internal operator terminal 200I” is a remote operator terminal 200 used by an internal operator OI for remote operation, and is installed in a remote operation management center. The management system 300 constantly monitors and manages the status of the plurality of internal operator OI. In addition, the management system 300 constantly monitors and manages the status of the plurality of internal operator terminal 200I.

On the other hand, the “external operator OE” is a remote operator O outside the remote operation management center. In other words, the external operator OE is engaged in remote operation servicing outside of the remote operation management center. For example, an external operator OE engages in remote operation servicing at home. The external operator OE may be a part-time remote operator O. The reliability of the external operator OE may be lower than the reliability of the internal operator OI. The “External Operator Terminal 200E” is a remote operator terminal 200 used by the external operator OE for remote operation and resides outside of the remote operation management center. The management system 300 does not always monitor the status of a plurality of external operator OE. The management system 300 may acquire the status of the plurality of external operator OE at predetermined timings (e.g., at the time of the allocation process). In addition, the management system 300 does not always monitor the status of the plurality of external operator terminals 200E. The management system 300 may acquire the status of the plurality of external operator terminal 200E at a predetermined timing (e.g., at the time of the allocation process).

According to the present embodiment, not only the internal operator OI and the internal operator terminal 200I but also the external operator OE and the external operator terminal 200E are utilized as needed. Basically, the internal operator OI and the internal operator terminal 200I are preferentially used. However, when the prescribed condition is satisfied, the external operator OE and the external operator terminal 200E are used. For example, the prescribed condition may include that the number or percentage of available (free) internal operator OI is less than or equal to the thresholds. As another example, the prescribed condition may include that the number or percentage of available (free) internal operator terminal 200I is less than or equal to the thresholds. The threshold may be zero.

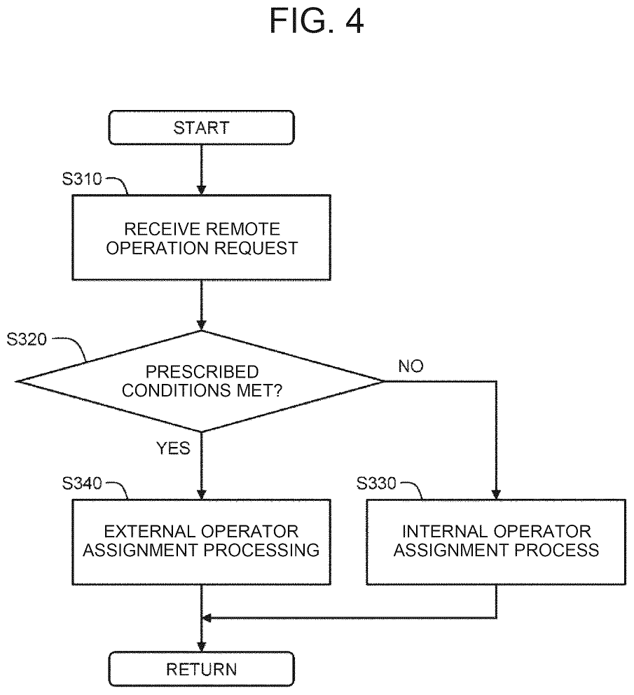

FIG. 4 is a flowchart illustrating an allocation process. In S310, the assignment processing unit 400 receives the remote operation request REQ related to the target mobility 100-X. In S320, the assignment processing unit 400 determines whether or not a prescribed condition is satisfied. When the prescribed condition is not satisfied (S320; No), the process proceeds to S330. In S330, the assignment processing unit 400 executes the internal operator assignment processing. Specifically, the assignment processing unit 400 selects an appropriate internal operator OI and an appropriate internal operator terminal 200I, and assigns them to remote operation of the target mobility 100-X.

On the other hand, if the prescribed condition is satisfied (S320: Yes), the process proceeds to S340. In S340, the assignment processing unit 400 executes the external operator assignment processing. Specifically, the assignment processing unit 400 selects an appropriate external operator OE (hereinafter referred to as “first external operator OE-X”) and an appropriate external operator terminal 200E (hereinafter referred to as “first external operator terminal 200E-X”). The assignment processing unit 400 assigns the external operator OE and the external operator terminal 200E to remote operation of the target mobility 100-X. Hereinafter, the external operator assignment process will be described in more detail.

### External Operator Assignment Processing

In order to realize an appropriate external operator assignment process, the following first to third aspects will be discussed. The assignment processing unit 400 executes the external operator assignment processing in consideration of at least one of the first to third aspects. The assignment processing unit 400 may execute the external operator assignment processing in consideration of two or more of the first to third aspects.

### First Aspect

### Assignment Processing Considering an Operator State and a Terminal State

With respect to the external operator OE, there may be conditions that are appropriate for remote operation and conditions that are not. If a first external operator OE-X that is inappropriate for remote operation is selected, the accuracy of the remote operation is reduced. Similarly, with respect to the external operator terminal 200E, there may be conditions that are appropriate for remote operation and conditions that are not. If the first external operator terminal 200E-X in an inappropriate condition for remote operation is used, the accuracy of remote operation is reduced.

Therefore, in the first aspect, the allocation process is performed considering the state of each external operator OE and the state of each external operator terminal 200E. To this end, the state of each external operator OE and the state of each external operator terminal 200E are quantified as “score”. The score is a quantitative parameter indicative of suitability to remote operation. For example, the score is calculated in a range of 0 to 100. The higher the score, the higher the suitability for remote operation. Based on the score, the first external operator OE and the first external operator terminal 200E-X are selected and assigned to remote operation of the target mobility 100-X.

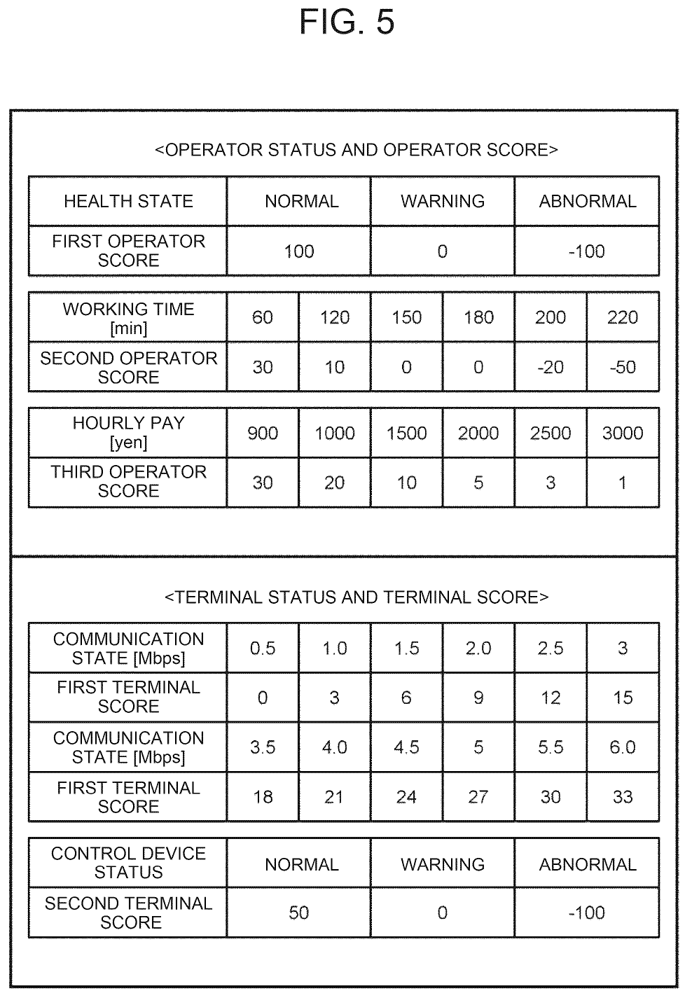

FIG. 5 is a conceptual diagram for explaining an example of a state and a score.

A first instance of a condition of an external operator OE is a health state of an external operator OE. For example, an external operator OE may use an external operator terminal 200E or its own terminal (e.g., a smart phone) to report its health state. As another example, an operator sensor 240 (see FIG. 1) may be utilized to detect a health state of an external operator OE. The operator sensor 240 includes a biometric sensor that detects biometric information of an external operator OE. Examples of the biological information include body temperature, heart rate, blood pressure, sweat amount, and the like. For example, the health state is obtained from the biological information by using the machine learning model. A first operator score is calculated based on the health state of the external operator OE. The first operator score is higher as the health state of the external operator OE is better.

A second instance of the condition of the external operator OE is the working time during which the external operator OE has been engaged in remote operation over a period of time in the past. The working time are obtained, for example, from the operation logs recorded in the external operator terminal 200E previously operated by the external operator OE. Alternatively, the working time are obtained from the working history of the respective external operator OE included in the operator control data MGT-O. A second operator score is calculated based on the working time of the external operator OE. The second operator score is lower as the working time of the external operator OE are longer.

A third exemplary condition of the external operator OE is the hourly pay of the external operator OE. For example, the external operator OE registers its hourly pay using the external operator terminal 200E or its own terminal (e.g., a smart phone). The hourly pays of the external operator OE may be registered in advance in the operator management information MGT-O and acquired from the operator management information MGT-O. A third operator score is calculated based on the hourly pay of the external operator OE. The third operator score is higher as the hourly pay of the external operator OE is lower.

A first exemplary state of the external operator terminal 200E is a communication state of the external operator terminal 200E. Examples of the communication state include a communication speed (throughput), a communication delay, and the like. The external operator terminal 200E can measure the communication rate, the communication delay, and the like based on the reception status of the data received from the communication partner. As another example, the external operator terminal 200E measures the communication rate, the communication delay, and the like based on the data transmitted to the communication partner and the feedback from the communication partner. A first terminal score is calculated based on the communication state of the external operator terminal 200E. The first terminal score is higher as the communication state of the external operator terminal 200E is better.

A second example of the state of the external operator terminal 200E is an abnormality degree of the control device 250 (see FIG. 1) of the external operator terminal 200E. For example, the control device 250 has a self-diagnosis function. The degree of abnormality is obtained from the self-diagnosis result (normal, warning, abnormality) by the self-diagnosis function. A second terminal score is calculated based on the abnormality degree of the control device 250. The second terminal score becomes lower as the abnormality degree of the control device 250 of the external operator terminal 200E is higher.

The external operator terminal 200E acquires “state information” indicating at least one of the status of the external operator OE and the status of the external operator terminal 200E. The status of the external operator OE includes at least one of the first through third instances described above. The status of the external operator terminal 200E includes at least one of the first example and the second example. Alternatively, the management system 300 may acquire the state information from the external operator terminal 200E. Then, the external operator terminal 200E or the management system 300 calculates a score based on the state information. Note that the state information used for calculating the score may be the latest state information or may be the state information of the past (for example, at the time of the previous assignment).

The score includes at least one of an operator score and a terminal score. The operator score indicates the suitability of the external operator OE for remote operation. The operator score includes at least one of the first to third operator scores. The operator score may be a sum of two or more of the first to third operator scores. Terminal score indicates the suitability of the external operator terminal 200E for remote operation. The terminal score includes at least one of the first and second terminal scores. The terminal score may be a sum of the first and second terminal scores. Alternatively, the score may be an integrated score in which the operator score and the terminal score are integrated. The integrated score indicates the suitability of the combined external operator OE and external operator terminal 200E for remote operation. In either case, the higher the score, the higher the suitability for remote operation.

The assignment processing unit 400 of the management system 300 acquires score information. The assignment processing unit 400 may register the operator scores of the plurality of external operator OE in the operator control data MGT-O. In addition, the assignment processing unit 400 may register the terminal scores of the plurality of external operator terminals 200E in the terminal control data MGT-T.

The assignment processing unit 400 selects an appropriate first external operator OE-X from a plurality of external operator OE based on the operator score and the operator management information MGT-O. More specifically, the assignment processing unit 400 extracts available (free) external operator OE from the plurality of external operator OE based on the operator control data MGT-O. Further, the assignment processing unit 400 selects the first external operator OE-X from the available external operator OE based on the operator score. For example, the assignment processing unit 400 preferentially selects an external operator OE having a higher operator score as the first external operator OE-X. If there is a plurality of candidates with the same operator score, an external operator OE with a longer latency may preferentially be selected as the first external operator OE-X. Then, the assignment processing unit 400 assigns the selected first external operator OE-X to the remote operation of the target mobility 100-X.

The assignment processing unit 400 selects an appropriate first external operator terminal 200E-X from the plurality of external operator terminals 200E based on the terminal score and the terminal management information MGT-T. More specifically, the assignment processing unit 400 extracts available (free) external operator terminal 200E from the plurality of external operator terminal 200E based on the terminal control data MGT-T. Furthermore, the assignment processing unit 400 selects the first external operator terminal 200E-X from the available external operator terminal 200E based on the terminal scores. For example, the assignment processing unit 400 preferentially selects the external operator terminal 200E having the higher terminal score as the first external operator terminal 200E-X. Then, the assignment processing unit 400 assigns the selected first external operator terminal 200E-X to the remote operation of the target mobility 100-X.

Alternatively, the assignment processing unit 400 may acquire the combined scores of the plurality of combinations of the external operator OE and the external operator terminal 200E. In this case, the assignment processing unit 400 selects an appropriate combination of the first external operator OE-X and the first external operator terminal 200E-X based on the integrated score, the operator management information MGT-O, and the terminal management information MGT-T. For example, the assignment processing unit 400 preferentially selects a combination of the external operator OE and the external operator terminal 200E having a higher integration score as a combination of the first external operator OE-X and the first external operator terminal 200E-X. Then, the assignment processing unit 400 assigns the selected first external operator OE-X and the first external operator terminal 200E-X to remote operation of the target mobility 100-X.

As described above, according to the first aspect, a score indicating the suitability of at least one of the external operator OE and the external operator terminal 200E for remote operation is calculated based on at least one of the state of the external operator OE and the state of the external operator terminal 200E. Based on the score, at least one of the first external operator OE-X and the first external operator terminal 200E-X assigned to the remote operation of the target mobility 100-X is selected. That is, the allocation process is performed in consideration of the conformity. This ensures the accuracy of remote operation of the target mobility 100-X.

The score may be performed by an external operator terminal 200E. The external operator terminal 200E only needs to transmit the score information to the management system 300. Therefore, the amount of communication between the external operator terminal 200E and the management system 300 is reduced. This contributes to the reduction of the communication resources used.

### Second Aspect

### Assignment Processing Considering an Operator License

In a second aspect, the allocation process is performed in view of the licenses that each of the plurality of external operator OE has. More specifically, the remote operation of the target mobility 100-X is assigned a first external operator OE-X having a requested license required for remote operation of the target mobility 100-X.

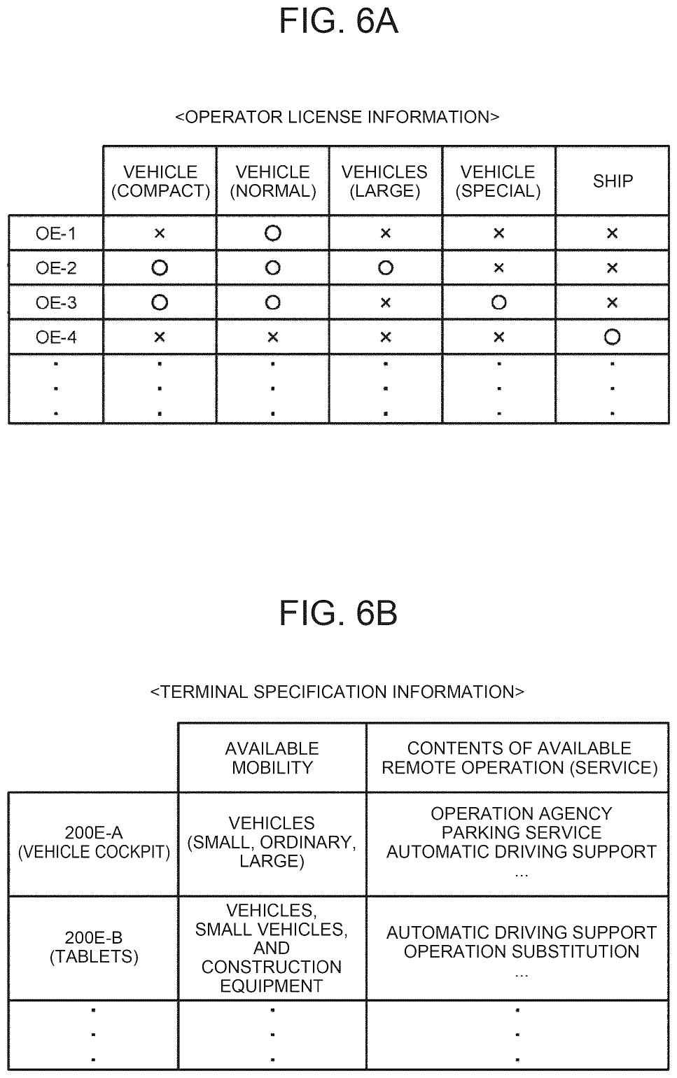

FIG. 6A illustrates an example of an operator license information. The operator license information indicates a license (qualification, license) possessed by each of the plurality of external operator OE for operating the plurality of types of mobility 100. In other words, the operator license information indicates a license held for each external operator OE. A license for a mobility 100 is one that officially allows the mobility 100 to be operated. Each external operator OE has one or more types of mobility 100 licenses. One external operator OE may hold a license for two or more types of mobility 100.

The operator license information is included in the operator management information MGT-O. For example, the external operator OE uses the external operator terminal 200E or its own terminal to declare licenses owned by the external operator terminal. The management system 300 generates operator license information in advance by collecting information on licenses held by the external operator OE, and updates the operator license information as needed.

The assignment processing unit 400 receives the remote operation request REQ. The remote operation request REQ indicates the type of the target mobility 100-X. The assignment processing unit 400 can recognize a “requested license” required for remote operation of the target mobility 100-X based on the type of the target mobility 100-X. The requested capability information includes information of a requested license.

The assignment processing unit 400 selects an appropriate first external operator OE-X from the plurality of external operator OE based on the operator control information MGT-O and the requested capability information. More specifically, the assignment processing unit 400 extracts available external operator OE from the plurality of external operator OE based on the operator control data MGT-O. Further, the assignment processing unit 400 acquires operator license information and information on a requested license. Then, the assignment processing unit 400 selects the first external operator OE-X having the requested license from the available external operator OE based on the operator license information and the requested license. The selected first external operator OE-X is assigned to a remote operation of the target mobility 100-X.

As described above, according to the second aspect, the licenses of the external operator OE and the requested licenses required for remote operation of the target mobility 100-X are considered. Then, the first external operator OE-X with the requested license is assigned to remote operation of the target mobility 100-X. This ensures the accuracy of remote operation of the target mobility 100-X. In addition, a situation in which an external operator OE that does not have the requested license is accidentally assigned to the target mobility 100-X is avoided. Therefore, it is not necessary to restart the allocation process from the beginning, and an efficient allocation process is realized.

### Third Aspect

### Assignment Processing Considering Terminal Specifications

In a third aspect, the allocation process is performed by considering the specifications of each of the plurality of external operator terminal 200E. More specifically, the remote operation of the target mobility 100-X is assigned a first external operator terminal 200E-X that satisfies the required terminal specifications required for the remote operation of the target mobility 100-X.

FIG. 6B illustrates an example of terminal specification information. The terminal specification information indicates the specifications of each of the plurality of external operator terminal 200E. In the embodiment illustrated in FIG. 6B, the terminal specification information indicates the type of the external operator terminal 200E, the type of the mobility 100 that can be supported, and the content of the remote operation that can be supported for each external operator terminal 200E.

Examples of the type of the external operator terminal 200E include a cockpit-type terminal, a PC, tablets, and a smart phone. If the type of the external operator terminal 200E changes, the type of mobility 100 that can be handled and the content of remote operation that can be handled also change. For example, a vehicle cockpit is suitable for remote operation of various types of vehicles, and is also suitable for traveling on public roads and driving long distances. On the other hand, tablets are not always suitable for traveling on public roads or driving long distances. The tablet can be used for short-distance driving of a vehicle in a limited area such as a parking lot, automatic driving assistance such as road shoulder evacuation in an emergency, remote operation of a small vehicle in a factory, and the like.

The terminal specification information is included in the terminal control information MGT-T. For example, the management system 300 collects the type of information from each of the plurality of external operator terminal 200E. The management system 300 generates the terminal specification information illustrated in FIG. 6B in advance based on the types of the external operator terminal 200E, and updates the terminal specification information as needed.

The assignment processing unit 400 receives the remote operation request REQ. The remote operation request REQ indicates at least one of “type of target mobility 100-X” and “content of desired remote operation of the target mobility 100-X”. Based on the remote operation request REQ, the assignment processing unit 400 can recognize the “request terminal specification” required for remote operation of the target mobility 100-X. The requested capability information includes information on a request terminal specification.

The assignment processing unit 400 selects an appropriate first external operator terminal 200E-X from the plurality of external operator terminals 200E based on the terminal control information MGT-T and the requested capability information. More specifically, the assignment processing unit 400 extracts available external operator terminal 200E from the plurality of external operator terminal 200E based on the terminal control data MGT-T. Furthermore, the assignment processing unit 400 acquires the terminal specification information and the information on the requesting terminal specification. Then, the assignment processing unit 400 selects the first external operator terminal 200E-X satisfying the request terminal specification from the available external operator terminal 200E based on the terminal specification information and the request terminal specification. The selected first external operator terminal 200E-X is assigned to remote operation of the target mobility 100-X.

As described above, according to the third aspect, the specifications of the external operator terminal 200E and the required terminal specifications required for remote operation of the target mobility 100-X are considered. Then, the first external operator terminal 200E-X satisfying the required terminal specification is assigned to remote operation of the target mobility 100-X. This ensures the accuracy of remote operation of the target mobility 100-X. In addition, a situation in which the external operator terminal 200E that does not have the required terminal specifications is erroneously allocated to the target mobility 100-X is avoided. Therefore, it is not necessary to restart the allocation process from the beginning, and an efficient allocation process is realized.

What is claimed is:

1. A remote operation system for a remote operation of a mobility, wherein:
an external operator is a remote operator outside of a remote operation management center that manages the remote operation of the mobility;
an external operator terminal is a remote operator terminal configured to be used by the external operator for the remote operation;
the remote operation system includes one or a plurality of processors; and
the one or a plurality of processors is configured to
acquire state information that shows at least one of a state of the external operator and a state of the external operator terminal,
calculate a score that shows a suitability of at least one of the external operator and the external operator terminal with respect to the remote operation based on the state information, and
select at least one of a first external operator and a first external operator terminal assigned to the remote operation of a target mobility based on the score.

2. The remote operation system according to claim 1, wherein the state of the external operator includes at least one of a health state of the external operator, a working time the external operator is engaged with the remote operation within a certain time period in past, and an hourly pay of the external operator.

3. The remote operation system according to claim 1, wherein the state of the external operator terminal includes at least one of a communication state of the external operator terminal and an abnormality degree of a control device of the external operator terminal.

4. The remote operation system according to claim 1, wherein:
there is a plurality of types of the mobility; and
the one or a plurality of processors is further configured to
acquire operator license information that shows a license of each of a plurality of external operators related to an operation of the plurality of types of the mobility,
acquire requested capability information that shows a requested license requested for the remote operation of the target mobility, and
select the first external operator having the requested license based on the operator license information and the requested license.

5. The remote operation system according to claim 1, wherein:
an internal operator is a remote operator within the remote operation management center;
an internal operator terminal is a remote operator terminal configured to be used by the internal operator for the remote operation;
a prescribed condition includes having a number or proportion of usable internal operators or usable internal operator terminals at or below a threshold; and
when the prescribed condition is established, the one or a plurality of processors assigns the first external operator and the first external operator terminal to the remote operation of the target mobility.
